(19) United States
(12) Patent Application Publication
(10) Pub. No.: US 2005/0206291 A1
(43) Pub. Date: Sep. 22, 2005

(54) Display device

(76) Inventors: Shigemi Hirasawa, Chiba (JP); Yoshiyuki Kaneko, Hachioji (JP); Yuuichi Kijima, Chosei (JP); Hiroshi Sasaki, Mobara (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/080,968

(22) Filed: Mar. 16, 2005

(30) Foreign Application Priority Data
Mar. 19, 2004 (JP) 2004-080940

(51) Int. Cl. H01K 1/18; H01J 1/62

(52) U.S. Cl. 313/292; 313/495

(57) ABSTRACT

A highly reliable display device is provided, in which a high quality display is possible and in which there is no fear of damage to a substrate, and the like by setting the buckling strength and the number of spacing retaining members (spacers) disposed in a display region. A self-sustainable spacer assembly is constituted by combining plural spacers; and, by dispersion-disposing the spacer assemblies in a display region, the spacing between both substrates is kept constant.

### BACKGROUND OF THE INVENTION

The present invention relates in general to a display device of the type utilizing an electron emission into a vacuum formed between a front face substrate and a back face substrate; and, more particularly, the invention relates to a display device which is capable of realizing a stable display characteristic by accurately retaining a desired spacing between the front face substrate and the back face substrate by using a spacing retaining member, which is disposed in a display region, which maintains a parallel disposition between both substrates, and which has a self-sustainable constitution.

Japanese Patent No. 2566155 Gazette describes a flat plate type image display device having, between a display substrate and a back face substrate, a spacer for retaining both of the substrates in position against the atmospheric pressure. For the spacer, metal plates combined in a lattice-like form are used, and a hole for vacuum evacuation is provided in the metal plate. With such a construction, the working and assembly of the spacer are easy, and a spacer having a desired height can be accurately formed. Further, the generation of cracks and chips owing to vibrations, an impact and the like can be prevented, and, thus, there are few image defects.

Further, Japanese Patent No. 2566155 Gazette also discloses a constitution in which the spacer serves as a black matrix by adapting the plate thickness of the metal plate to the space between fluorescent substances on the display substrate, and, thus, it is possible to obtain also an improvement in image contrast without separately forming the black matrix.

Further, JP-A-2001-338528 Gazette discloses an image forming device, in which, by bonding a back face plate and a spacer using a seal-bonding member formed by heating and firing an electrically conductive frit for seal-bonding, which contains a glass and at least one metal selected from a group consisting of Si, Zn, Al, Sn and Mn, and in which the members are mutually bonded, an electrical conductivity can be provided without generating a thermal stress.

Further, JP-A-2002-358915 Gazette discloses the fact that seal-bonding of a vacuum envelope can be easily and surely performed by seal-bonding a front face substrate and a side wall through an aluminum film and forming a support member such that its height is lower than that of the side wall, and that, additionally, an image display device having a high vacuum tightness can be obtained by causing the front face substrate to surely make contact with a bonding face of the side wall without an interstice.

### SUMMARY OF THE INVENTION

In connection with the technical features described above, if the spacer is constituted by combining many metal plates in a lattice-like form, even if each metal plate is formed with a high accuracy, the accumulation of errors, owing to the fact that the many metal plates are combined in the lattice-like form, becomes large. For this reason, there is a concern that one part of an effective image may be shielded by the spacer, with the result that an image defect occurs. Thus, there has been a problem in that the dimensional accuracy required in a display device of this kind cannot be satisfied.

Further, if the spacer is constituted such that its height is lower than the side wall, there is a concern that warping may occur in the front face substrate and the back face substrate, and there has been a concern that cracking of the substrates accompanying the warping may occur. There is also the problem that it is difficult to mention a uniform spacing between both of the substrates over the whole face of the substrates.

The above-described problems can be solved by specifying the compressive stresses of both of the substrates, and the number and the buckling strengths of the spacing retaining members (hereafter referred to as spacer assemblies) disposed between both of the substrates, by constituting the spacer assembly from a ceramic and making it into a self-sustainable constitution, and by disposing the spacer assembly in a display region as plural pieces.

According to the invention, it is possible to obtain a large display device in which cracking of the substrate due to atmospheric pressure is prevented, and in which the spacing between both of the substrates can be accurately retained with a high fineness. Further, since the buckling strength is high by about several times in comparison with a spacer assembly made of glass, it is possible to reduce the number of spacer assemblies to be disposed per unit area, so that it is possible to reduce the possibility that one part of the effective image will be shielded by the spacer assembly, thereby generating an image defect.

According to the present invention, by using a spacer assembly comprising an aggregate of elements having a self-sustainable constitution by combining plural plate-like support members (hereafter referred to as spacers), it is possible to prevent the spacer assembly from toppling or inclining, and the spacing between both the substrates can be accurately retained. Further, due to the fact that the spacer assembly has been dispersion-disposed as plural pieces, it is possible to avoid the possibility that one part of the effective image will be shielded by a spacer assembly, thereby generating an image defect. Additionally, since the spacer assembly is self-sustainable, fixing the spacer assembly to the substrate is easy to achieve as well.

According to the invention, by changing the height of one or plural pieces, among the plural spacers constituting one spacer assembly, from that of other pieces, it is possible to achieve a desired high vacuum in a short time without reducing the evacuation conductance, so that the working efficiency is improved. Additionally, the contact area with the substrate decreases, and thus it is possible to reduce damage to the electrodes and generation of chips in the spacer.

According to the invention, due to the fact that one or plural spacers constituting the spacer assembly is or are caused to have an engaging part for combining the spacers, the spacing between both the substrates can be accurately retained by increasing the dimensional accuracy of the spacer assembly, so that a high quality display becomes possible.

According to the invention, due to the fact that the depth of the engaging part has been set with the height of the spacer being used as a reference, self-sustainment of the spacer assembly is made possible. Further, due to the fact that concave part bottom faces of the engaging spacers do not mutually contact each other, a stress concentration in the concave part can be avoided, and thus it becomes possible to retain the strength of the spacer, and additionally it is possible to form the combined spacer assembly so as to have a predetermined height.

According to the invention, it is possible to avoid a disturbance of the electric field by the spacer assembly, and, from the fact that the spacer assembly is self-sustainable, the working process can be shortened.

### BRIEF DESCRIPTION OF THE DRAWINGS

FIG. 1(a) is a plan view of a display device as seen from a front face substrate side, and FIG. 1(b) a side view thereof as seen from an A direction in FIG. 1(a);

FIG. 2 is a plan view of a back face substrate shown with the front face substrate of FIG. 1(a) and FIG. 1(b) being removed;

FIG. 3 is a sectional view taken along line B-B in FIG. 2, showing the back face substrate and the front face substrate of a portion corresponding to that back face substrate;

FIG. 4 is a sectional view taken along line C-C in FIG. 2, showing the back face substrate and the front face substrate of a portion corresponding to that back face substrate;

FIG. 5 is an enlarged sectional view of a main part in FIG. 4;

FIG. 6(a), FIG. 6(b) and FIG. 6(c) are diagrams showing details of a spacer assembly, wherein FIG. 6(a) is a plan view, FIG. 6(b) is a side view and FIG. 6(c) is a front view;

FIG. 7 is a perspective view of a long spacer;

FIG. 8 is a perspective view of a short spacer;

FIG. 9 is a perspective view of an engaging part;

FIG. 10(a), FIG. 10(b) and FIG. 10(c) are diagrams showing another example of the spacer assembly of the present invention, wherein FIG. 10(a) is a plan view, FIG. 10(b) is a side view and FIG. 10(c) is a front view;

FIG. 11 is a perspective view of a second long spacer;

FIG. 12(a), FIG. 12(b) and FIG. 12(c) are diagrams showing another example of the spacer assembly of the present invention, wherein FIG. 12(a) is a plan view, FIG. 12(b) is a side view and FIG. 12(c) is a front view;

FIG. 13 is a perspective view of a 3rd long spacer;

FIG. 14 is a perspective view of a 2nd short spacer;

FIG. 15 is a perspective view showing still another example of the spacer assembly of the present invention;

FIG. 16 is a plan view showing another example of a disposition pattern for the spacer assembly of the present invention;

FIG. 17 is a plan view showing still another example of the disposition pattern of the spacer assembly of the present invention;

FIG. 18(a), FIG. 18(b) and FIG. 18(c) are diagrammatic views illustrating a method of securing the spacer assembly and the substrate in accordance with the manufacturing method of the present invention, wherein FIG. 18(a) is a plan view, FIG. 18(b) is a main part plan view and FIG. 18(c) is a main part sectional view taken along line D-D in FIG. 18(a);

FIG. 19 is a plan view showing still another example of the disposition pattern of the spacer of the present invention; and

FIG. 20 is a perspective view showing still other example of the spacer of the invention.

### DESCRIPTION OF THE PREFERRED EMBODIMENTS

Hereunder, embodiments of the invention are explained.

### Embodiment 1

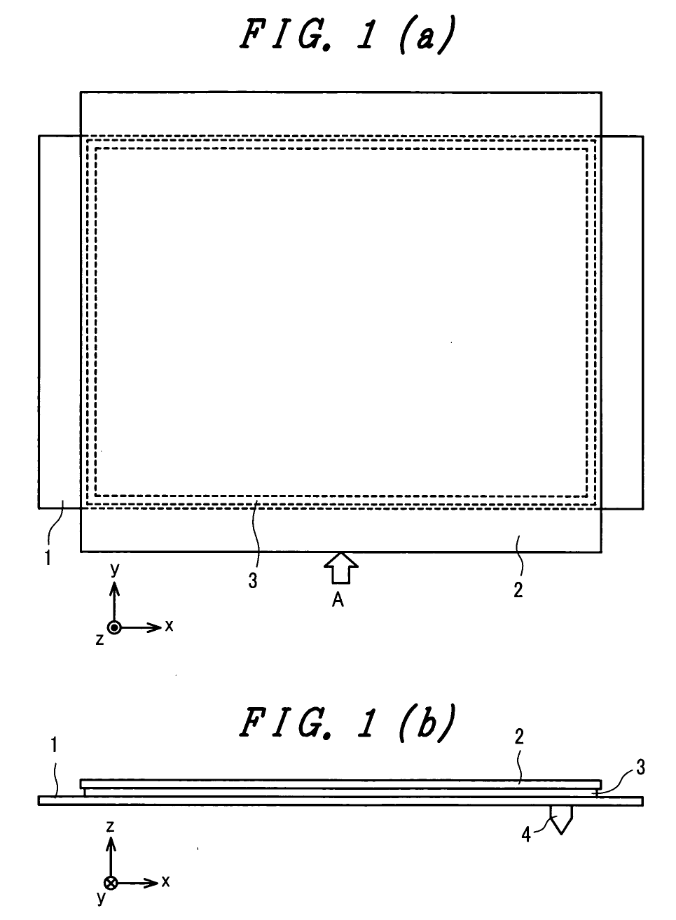

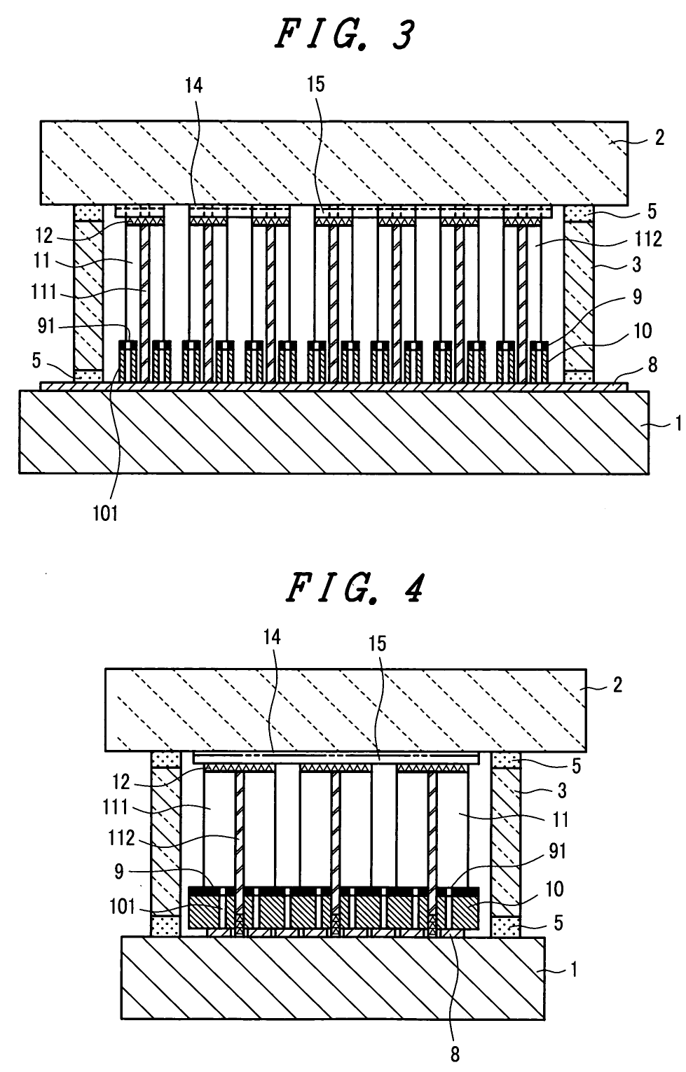

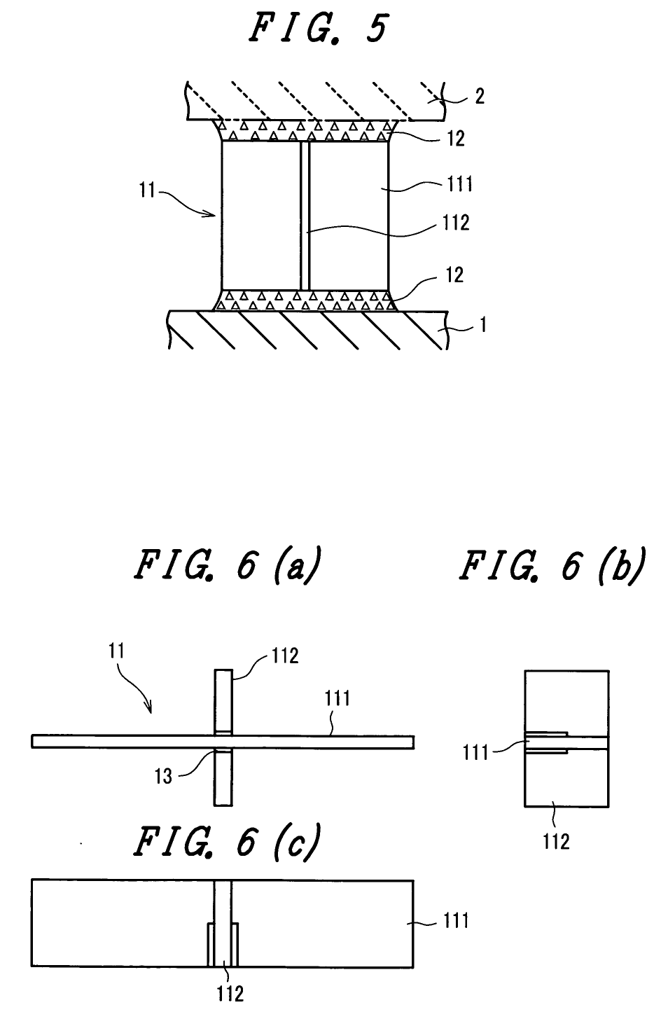

FIG. 1(a) to FIG. 5 show one embodiment of a display device in accordance with the present invention.

As seen in FIG. 1(a) to FIG. 5, the display device includes a back face substrate 1 and a front face substrate 2, each of which is constituted by a glass plate of several mm, e.g., 3mm, in thickness. Between the substrates 1 and 2, there is a support body 3, which is constituted by the glass plate of several mm, e.g., 3 mm, in thickness, or a sintered body of frit glass. An evacuation tube 4 is provided to effect evacuation of the space between the substrate. The support body 3 is interposed between the substrates while encircling a peripheral edge part between both of the substrates 1, 2 and is air-tightly seal-bonded to both of the substrates 1, 2 through a seal-bonding member 5, such as frit glass. A space defined by the support body 3, both of the substrates 1, 2 and the seal-bonding member 5 is evacuated through the evacuation tube 4, to retain a degree of vacuum of 10⁻³-10⁻⁵ Pa, for instance. Further, the evacuation tube 4 is attached to an outer surface of the back face substrate 1, and it communicates with a through-hole 7 penetrating through the back face substrate 1. The central portion of the panel provide a display region 6.

Cathode wiring lines 8 are formed as plural pieces which extend in one direction (X-direction) on an inner surface of the back face substrate 1, and they are formed as plural lines juxtaposed in the other direction (Y-direction) intersecting with this one direction. The cathode wiring lines 8 are formed by vapor deposition, for instance, or they are provided by thick-film-printing a silver paste, in which a low melting point glass exhibiting an insulating property has been mixed with electrically conductive silver particles whose particle diameters are several μm, e.g., 1-5 μm, for instance, and by sintering the silver paste at about 600° C., for instance, and the like.

Further, on a surface of the cathode wiring lines 8, electron sources (not shown in the drawing) containing a carbon nano-tube (CNT) are disposed at a predetermined pitch. Additionally, one end of the cathode wiring lines 8 is drawn out to the outside of the support body 3. Above the wiring lines 8, there is a control electrode 9 spaced by an insulating layer 10, and the control electrode 9 has an electron passing-through hole 91 disposed at the same pitch as the cathode wiring lines 8. Further, the insulating layer 10 has an opening 101 that is coaxial with the electron passing-through hole 91. The insulating layer 10 is formed by the thick-film-printing, or by a method such as a combination of a dry film process and an etching process. Further, the control electrode 9 is constituted by a method of directly printing it to the upper face of the insulating layer 10 by use of a silver paste, for instance, or by a method of lamination-forming it by a metal vapor deposition process and a method of plating etc. Additionally, a method of mounting a separate member, and the like, may be employed.

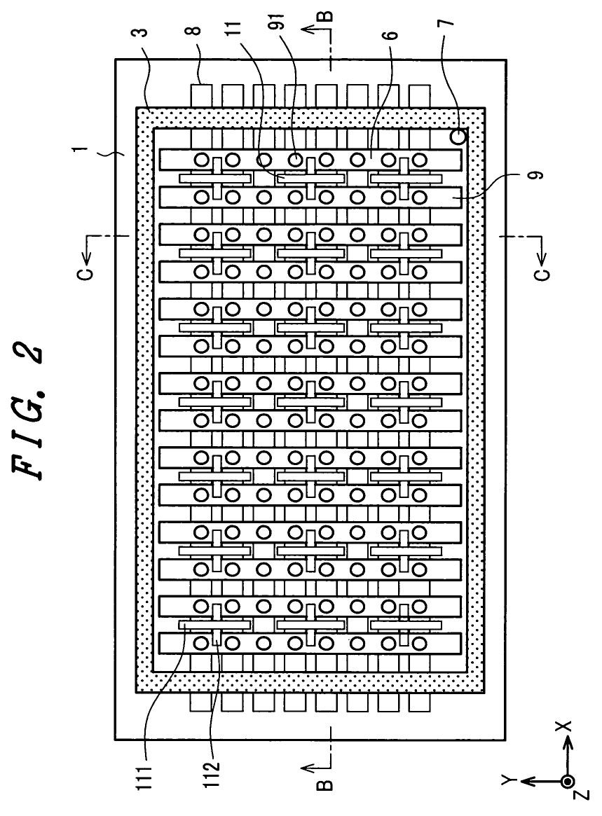

A spacer assembly 11, made of a ceramics material, is disposed between the back face substrate 1 and the front face substrate 2, and its upper and lower end faces are secured respectively, to the back face substrate 1 and the front face substrate 2 by an electrically conductive member 12, such as like an adhesive containing silver, for instance. The constitution of the spacer assembly 11 is such that a plate-like long spacer 111 and a similar a plate-like short spacer 112, which is shorter than the long spacer 111, are fitted in respective engaging portions so as to be perpendicularly disposed, thereby forming a self-sustainable aggregate having an approximately cross shape, as seen in FIG. 2.

The spacer assemblies 11, each of which comprises a self-sustainable aggregate, are dispersion-disposed in the display region 6. As to the number and positions of the depositions of the spacer assemblies 11, these parameters are selected such that the stress produced by the atmospheric pressure is applied approximately uniformly to each of the disposed spacer assemblies 11, and thus damage to the substrates and a buckling of the spacer assembly do not occur. And, as mentioned above, the upper and lower end faces of each spacer assembly 11 are secured, respectively, to the back face substrate 1 and the front face substrate 2 by an electrically conductive member 12.

On the other hand, on a back face substrate 1 side of the front face substrate 2, there are a fluorescent substance layer 14 and a metal-backed layer (anode) 15, covering the fluorescent substance layer 14. An electron beam, which has been emitted from the electron source and has passed through the opening 101 of the insulating layer 10 and the electron passing-through hole 91 of the control electrode 9, penetrates through the metal-backed layer (anode) 15 and impinges against the fluorescent substance layer 14, thereby emitting light. Further, although not shown in the drawing, there is adopted a constitution is adopted in which the circumference of the fluorescent substance layer 14 is surrounded by a black matrix (BM) film.

FIG. 6(a), FIG. 6(b) and FIG. 6(c) are views showing details of the spacer assembly 11 according to this embodiment.

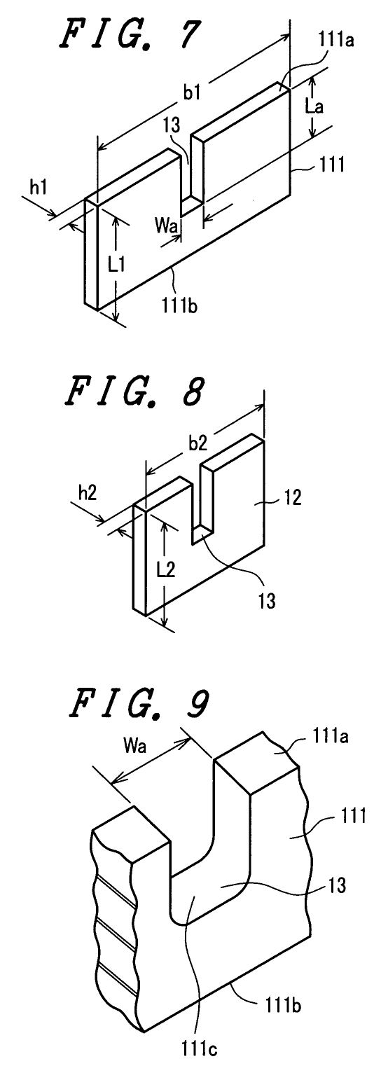

As seen in FIG. 6(a) to FIG. 6(c) and FIG. 7, the long spacer 111 is a plate-like spacer which is b1 in length, L1 in height and h1 in thickness, and it possesses an engaging part 13 at approximately the center of the length b1. The engaging part 13 has an opening in one end face 111a side, and it consists of an approximately rectangular concave part which extends toward the other end face 111b from the opening and is Wa in width and La in depth. Additionally, its bottom part 111c is rounded, as seen in FIG. 9, in order to avoid a stress concentration at the bottom of the opening. The depth La of the engaging part 13 is set to ⅔- 7/15 of the spacer height L1, and is such that, when the spacer is combined with the other short spacer 112, the bottom part 111c is not in contact with a bottom part of the other short spacer 112. If the depth La of the engaging part 13 is too deep, while deviating from the above-stated range, a decrease in strength becomes a problem; and, conversely, if it is too shallow, there is a problem in the dimension of the spacer assembly and a fear that the spacer will be damaged when the spacers are combined, so that a dimension inside of the above-stated range is desirable.

On the other hand, as to the short spacer 112, as seen in FIGS. 6(a) to 6(c) and FIG. 8, the height L2, the thickness h2 and the engaging part 13 are respectively the same as the dimensions and the shape of the corresponding elements of the long spacer 111, except that the length b2 is short in comparison with the length b1 of the spacer 111. An aggregate, in which the long spacer 111 and short spacer 112 have been fitted together by way of the engaging parts 13 so as to be disposed perpendicularly and in which the heights have been made the same as L1, forms the spacer assembly 11.

The spacer assembly 11, as mentioned before, provides the function of retaining the required spacing between both the substrates to a predetermined value, while resisting against a load applied to both of the substrates 1, 2, and, therefore, it is required to have a desired buckling strength Pₖ.

Here, the buckling strength Pₖ of a spacer of this kind is represented by a general Expression 1 as mentioned below. That is,
Pₖ=nπ²EI/L² (Expression 1)
where,
n: coefficient determined by supporting method
E: Young's modulus (kgf/mm²)
I=second moment of area (mm⁴)
L=spacer height (mm).

Further, a compressive stress a and a limit compressive stress σₖ are represented respectively by Expressions 2 and 3 as mentioned below.

First, the compressive stress σ becomes
σ=W/(b×h×S) (Expression 2)
where,
W load (surface area×pressure)
b=spacer length (mm)
h=spacer plate thickness
S: spacer number (pieces).

Further, the limit compressive stress σₖ becomes
σₖ=Pₖ/(b×h) (Expression 3).

Generally, the substrates 1, 2 are several mm, e.g., about 3 mm, in plate thickness, and consist of a high distortion spot glass of the type used in a flat plate type display device, such as plasma display panel. However, the bending stress of this glass plate is at most about 6.7 kgf/mm²; and, accordingly, if the spacing of the spacer is large, there is a fear that the glass plate may be broken by the atmospheric pressure, so that it is desirable to dispose the substrates with a spacing of about 50 mm or less, if safety is taken into consideration. Further, it is desirable for the spacer to have a buckling strength capable of withstanding the atmospheric pressure applied to at least 100 cm².

The present invention has made it possible to provide a display device whose reliability is high by creating a relation among the buckling strength Pₖ, the limit compressive stress σₖ and a spacer number S as follows:
1≦σₖ·S/Pₖ<10
to thereby eliminate the possibility of damage to the substrates and the spacer by an optimum disposition of the spacer.

Here, if the value of σₖ·S/Pₖ is less than 1, the reliability in retaining the spacer cannot be ensured, and it becomes difficult to retain both the substrates in a parallel disposition, so that there is a problem from the point of view of safety. On the other hand, if the above-stated value exceeds 10, a reduction in the workability cannot be avoided, and, as a more important problem, it becomes difficult to ensure a mutual, positional relation with each electrode, so that there is a concern that a display defect will be generated.

Accordingly, if the safety, the workability, the display quality and the like are synthetically considered, the relationship
3≦σₖ·S/Pₖ<5
is found to be most desirable.

As a specific example of the above-mentioned embodiment, the spacer is made of a ceramic, and both of the substrates 1, 2 are bond-secured through the support body 3 with a substrate spacing of 3 mm. Accordingly,
E=40000, L=3 mm and n=4,
   further, the space dimensions are such that
h₁=0.05 mm, b₁=85 mm, b₂=10 mm, h₂=0.05 mm and the dimension of the area surrounded by the support body 3 is 470 mm×455 mm, and,
   additionally, the second moment of area I of the spacer assembly 11, in which the two long and short plate-like spacers 111, 112 have been combined to form a cross, becomes
   I=(b₁×h₁³+b₂×h₂³)/12.

In this example, if the buckling strength Pₖ of the spacer assembly 11 is calculated, it becomes
Pₖ=(4×3.14×3.14×40000×I)/(3×3), and, further
from I=(85×0.053+10×0.053)/12, it becomes
Pₖ=173(kgf).
That is, the buckling load of the spacer assembly 11 becomes
Pₖ=173(kgf).
On the other hand, σₖ=Pₖ/(b×h) becomes
σₖ=36.4(kgf/mm²).
Accordingly, from 1<σₖ·S/Pₖ<10, S becomes
S=5-47 pieces.

By way of example, in the arrangement shown in FIG. 2, the spacer assemblies 11 are disposed as 21 pieces, and the spacing between the spacer assemblies 11 is 50 mm in both the X- and Y-directions.

Further, from W/(b×h×S), the compressive stress y becomes 470×455×0.01 (atmospheric pressure)/(85×0.05+10×0.05)S, and, in the example of FIG. 2, the compressive stress σ becomes 21.4 (kgf/mm²).

In this embodiment, it is possible to the spacer assembly while considering the workability, the safety and the like, and it is possible to provide a display device whose reliability is high and in which cracking of the substrate is eliminated, and the buckling of the spacer assembly is eliminated as well. Further, as to the number of these spacer assemblies, it becomes possible to select a small number from the point of view of the workability and a large number from the point of view of the safety.

Additionally, from the fact that each spacer assembly 11 has the self-sustainable constitution, the work required for fixing it to the substrate becomes easy, and it has a characteristic that the mutual position with respect to each electrode can be accurately controlled, and, needless to say, it is possible to improve the workability.

Further, owing to the fact that each spacer assembly 11 has a self-sustainable constitution, since the mutual position thereof can be kept constant when secured to the substrate, it is possible to avoid a distortion of the substrate after the assembly, so that it is possible to provide a display device whose dimensional accuracy is high. Further, the plate-like spacers can be made into a spacer assembly having a self-sustainable characteristic by combining them by engaging the parts, so that the stability of the spacer assembly also can be easily ensured.

### Embodiment 2

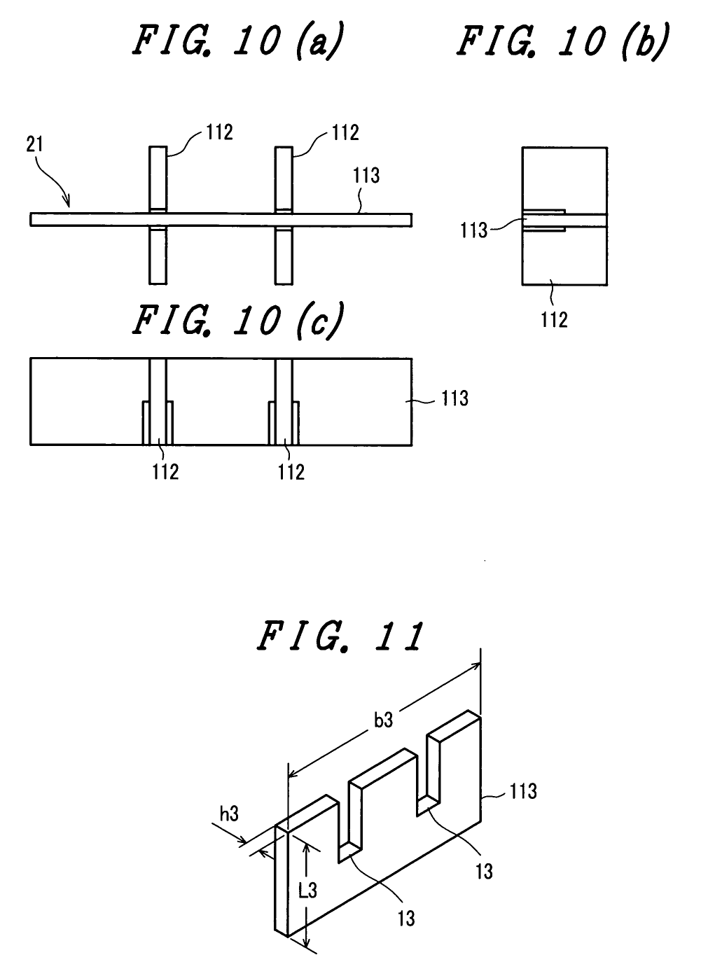

FIG. 10(a), FIG. 10(b) and FIG. 10(c) are views showing another example of the spacer assembly used in the display device of the present invention, wherein FIG. 10(a) is a plan view, FIG. 10(b) is a side view and FIG. 10(c) is a front view. As seen in FIGS. 10(a) to 10(c) and FIG. 11, the 2nd long spacer 113 is provided with three engaging parts 13 at positions approximately trisecting the length b3; while, the height L3, the thickness h3 and the engaging parts 13 are respectively the same as the dimensions and shape of the long spacer 111 of the first embodiment.

Each engaging part 13 of the 2nd long spacer 113 and the engaging part 13 of the short spacer 112 are respectively fitted together so as to be perpendicularly disposed, and the combination whose height corresponds to the height L3 is formed into a spacer assembly 21. The height L3, the thickness h3 and the engaging parts 13 have respectively the same dimensions and shape of the long spacer 111 of the first embodiment.

In this constitution, the buckling strength becomes additionally higher than the spacer assembly 11 of the first embodiment, and the buckling load of the spacer assembly 21 becomes Pₖ≈192 (kgf).

On the other hand, σₖ=Pₖ/(b×h) becomes
σₖ≈36.6 (kgf/mm²).

Accordingly, from 1≦σₖ·S/Pₖ<10, S becomes
S=6-53 pieces.

Further, from the relationship for compressive stress σ=W/(b×h×S), the compressive stress σ becomes 19.4 (kgf/mm²) at S=21, similar to the example of FIG. 2.

In this embodiment, self-sustainment of the spacer assembly 21 becomes additionally easy, so that it is possible to prevent the spacer assembly from toppling or inclining. Accordingly, it becomes additionally easy to dispose the spacer assembly while considering the workability, the safety and the like, and it is possible to provide a display device whose reliability is high and in which cracking of the substrate is eliminated, and buckling of the spacer assembly is eliminated as well. As mentioned before, as to the number of these spacer assemblies, it becomes possible to select a small number from the point of view of the workability and a large number from the point of view of safety.

### Embodiment 3

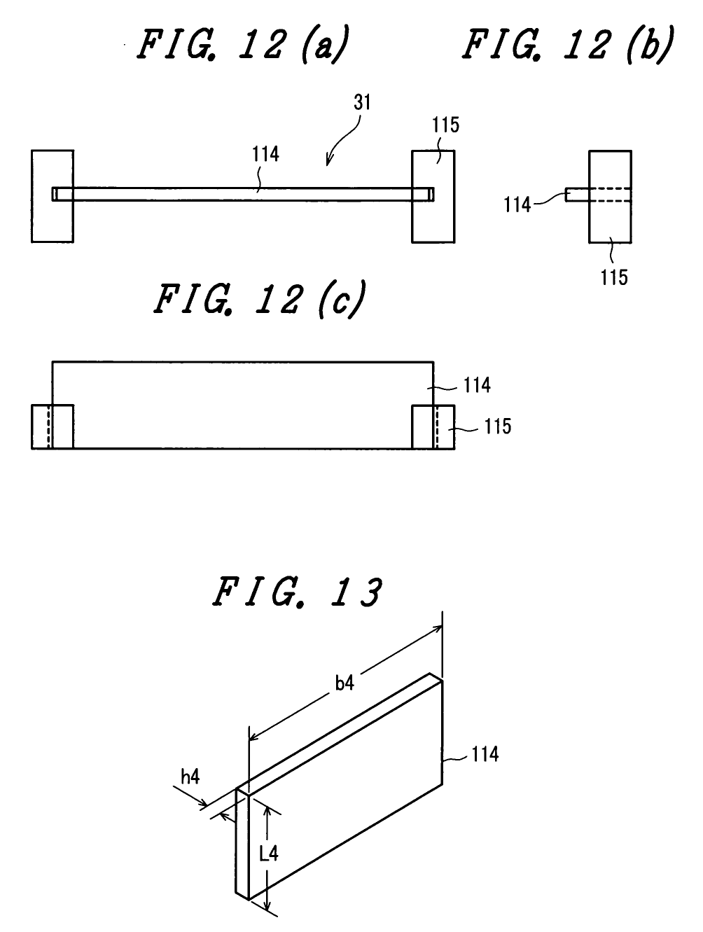

FIG. 12(a), FIG. 12(b) and FIG. 12(c) are views showing another example of the spacer assembly used in the display device of the present invention, wherein FIG. 12(a) is a plan view, FIG. 12(b) is a side view and FIG. 12(c) is a front view. The 3rd long spacer 114 in this embodiment, as seen in FIG. 13, has no engaging part, while the height L4 and the thickness h4 are respectively the same as the corresponding dimensions of the long spacer 111 of the first embodiment.

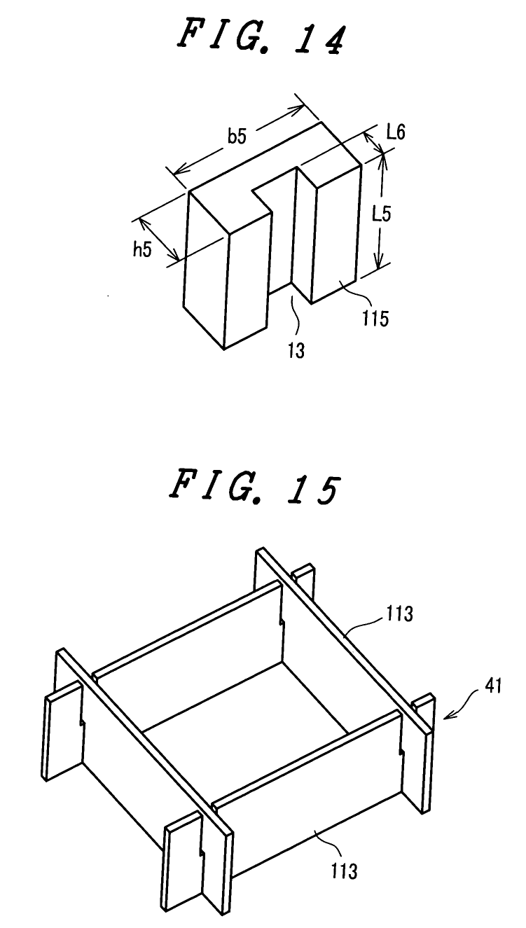

On the other hand, as to the 2nd short spacer 115, as seen in FIG. 14, the plate thickness h5 is at least about two times or so more than that of the plate thickness h2 of the 1st short spacer 112 of the first embodiment, the height L5 is shortened to about ½ or so of the height L4 of the 3rd long spacer 114, and additionally the depth L6 of the engaging part 13 is about ½ or so that of the plate thickness h5.

Both ends of the 3rd long spacer 114 are respectively fitted to the engaging parts 13 of the 2nd short spacers 115 so as to be perpendicularly disposed, and a combination whose height is the same as the height L4 is formed into a spacer assembly 31.

In this constitution, a gas flow passage is formed for use at an evacuation time, and, needless to say, the 2nd short spacer 115 contributes to the self-sustainment of the spacer assembly 31. Additionally, if a through-hole is provided in the long spacer 114, it is helpful in improving the evacuation efficiency.

The buckling strength of the spacer assembly 31 is lower than that of the spacer assembly 11, and the buckling load of the spacer assembly 31 becomes Pₖ≈155 (kgf).

On the other hand, σₖ=Pₖ/(b×h) becomes
σₖ≈36.5(kgf/mm²).

Accordingly, from 1≦σₖ·S/Pₖ<10, S becomes
S=5-43 pieces.

Further, from the relationship for compressive stress σ=W/(b×h×S), the compressive stress σ becomes 24 (kgf/mm²) at S=21, similar to the example of FIG. 2.

In this embodiment, self-sustainment of the spacer assembly 31 becomes easy, so that it is possible to prevent the spacer assembly from toppling or inclining, and further it becomes possible to make the height of the spacer assembly uniform. Accordingly, it becomes additionally easy to dispose the spacer assembly while considering the workability, the safety and the like, and it is possible to provide a display device whose reliability is high and in which cracking of the substrate is eliminated, and buckling of the spacer assembly is eliminated as well. As mentioned before, as to the number of these spacer assemblies, it becomes possible to select a small number from the point of view of the workability and a large number from the point of view of safety.

### Embodiment 4

FIG. 15 is a perspective view showing still another example of the spacer assembly used in the display device of the present invention, and the same reference numerals are applied to the same portions or a portion having the same function in the drawings mentioned before. In FIG. 15, a spacer assembly 41 is one made into a square-like aggregate by combining four 2nd long spacers 113 by way of a respective engaging part 13. Here, it is also possible to improve the evacuation conductance by providing a through-hole in an intermediate portion and the like of each long spacer 113.

In this embodiment, self-sustainment of the spacer assembly 41 becomes easy, so that it is possible to prevent the spacer assembly from toppling or inclining. Accordingly, it becomes additionally easy to dispose the spacer assembly while considering the workability, the safety and the like, and it is possible to provide a display device whose reliability is high and in which cracking of the substrate is eliminated, and buckling of the spacer is eliminated as well. As mentioned before, as to the number of these spacer assemblies, it becomes possible to select a small number from the point of view of the workability and a large number from the point of view of safety.

### Embodiment 5

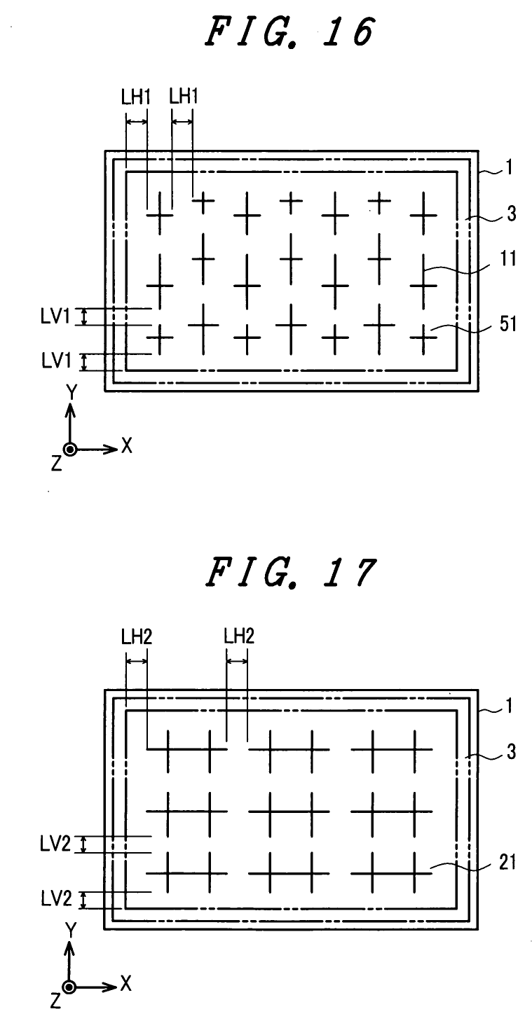

FIG. 16 is a plan view showing another example of the disposition of the spacer assembly in the display device of the present invention. In FIG. 16, there is a disposition which can uniformly retain the whole area of the display region 6, by combining the spacer assembly 11 of FIGS. 6(a)-6(c) with a spacer assembly 51, which is constituted by an aggregate formed by combining the two short spacers 112 to form the spacer assembly 51, which is smaller than the spacer assembly 11.

That is, spacer assemblies of two different kinds having different in their dimensions are suitably combined; and, in a region where the spacer assembly 11 cannot be disposed, the spacer assembly 51, which is smaller than the spacer assembly 11, is disposed in its place. And, plural spacer assemblies are disposed in a Y-direction at an equal interval, with an interval between the mutual spacer assemblies and an interval between the outermost spacer assembly and the support body 3 in the Y-direction being respectively LV1. Additionally, the plural spacer assemblies are disposed in an X-direction at an equal interval with an interval between the plural-row mutual spacer assemblies and an interval between the outermost spacer assembly and the support body 3 in the X-direction being respectively LH1.

In this embodiment, due to the fact that the plural spacer assemblies, which are formed of the spacer assemblies 11 and the spacer assemblies 51 having different dimensions, are combination-disposed, the whole area of the substrate is uniformly retained. Thus, the stress due to the atmospheric pressure is approximately, uniformly applied to each of the disposed spacer assemblies 11, 51, so that it is possible to provide a display device whose reliability is high and in which damage to the substrate and also buckling of the spacer assembly are eliminated. Further, from the fact that each of the spacer assemblies 11, 51 has a self-sustainable constitution, the work required for fixing it to the substrate becomes easy, and it has the characteristic that the mutual position with respect to each electrode can be accurately controlled, needless to say, it is possible to improve the workability. Additionally, due to the fact that the interval between the outermost spacer assembly and the support body 3 has been made approximately the same as the interval between the mutual spacer assemblies, the outermost spacer assembly becomes less subject to the influence of the process of fixing the support body to the seal-bonding member, so that the whole area of the display region can be retained approximately uniformly.

### Embodiment 6

FIG. 17 is a plan view showing still another example of the disposition of the spacer assembly in the display device of the present invention. In FIG. 17, plural spacer assemblies 21 are disposed over the whole area of the display region 6 in the Y-direction at an equal interval, with an interval between the mutual spacer assemblies and an interval between the outermost spacer assembly and the support body 3 in the Y-direction being respectively LV2. Additionally, the plural spacer assemblies are disposed in the X-direction at an equal interval, with an interval between the plural-row mutual spacer assemblies and an interval between the outermost spacer assembly and the support body 3 in the X-direction being respectively LH2, whereby each spacer assembly 21 is capable of uniformly retaining the substrate.

In this embodiment, by using one kind of spacer assembly, a load is uniformly applied to each spacer assembly, and, thus, it is possible to prevent damage the spacer assembly. Further, the jig structure that is used when fixing the spacer assembly can be simplified, and, in addition, the work management becomes easy. Additionally, from the fact that each spacer assembly 21 has a self-sustainable constitution, the work required for fixing it to the substrate becomes easy, and it has the characteristic that the mutual position with respect to each electrode can be accurately controlled, and, needless to say, it is possible to intend to improve the workability.

### Embodiment 7

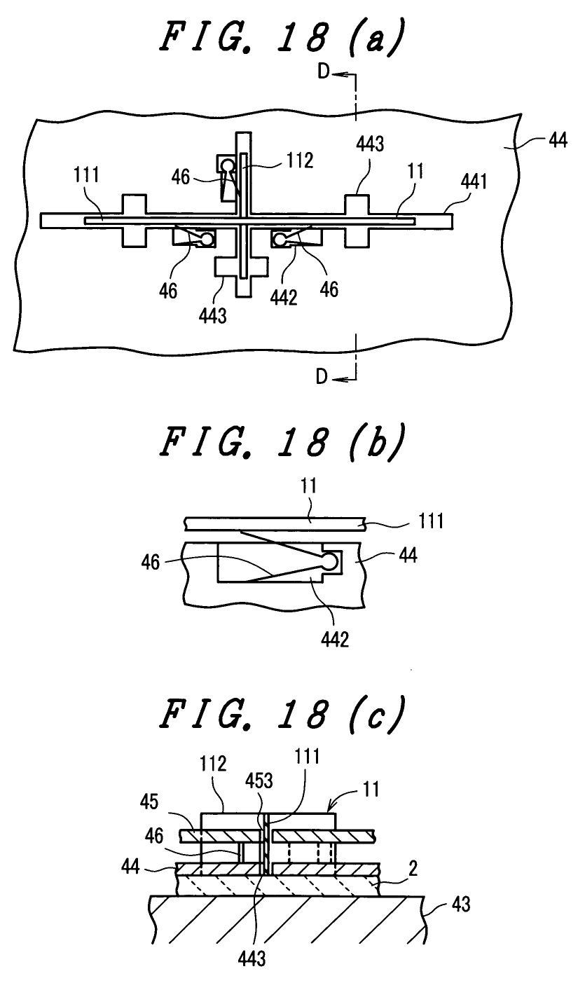

FIG. 18(a), FIG. 18(b) and FIG. 18(c) are diagrammatic views illustrating a method of securing the spacer assembly and the substrate in the manufacture of the display device of the present invention, wherein FIG. 18(a) is a plan view, FIG. 18(b) is a plan view and FIG. 18(c) a sectional view taken along line D-D in FIG. 18(a). In FIG. 18(a), FIG. 18(b) and FIG. 18(c), an outer face side of the front face substrate 2, having on its inner face the fluorescent substance layer, the anode and the like, is positioned on and fixed to a soaking base 43. Next, the spacer assembly 11 is fixed onto the inner face of the front face substrate 2 through an electrically conductive adhesive, such as silver paste. For this process, a spacer attaching plate 44, a spacer fixing plate 45, plural leaf springs 46, which will be mentioned later, and the like, are used.

The spacer attaching plate 44 possesses a cross-shaped through-hole 441, whose shape is approximately the same as that of the spacer assembly 11, a spring accommodation part 442 communicating with the through-hole 441 and accommodating the leaf spring 46, and an inspection hole 443, communicating with the through-hole 441 and whose width is wider than the through-hole 441. Further, the spacer fixing plate 45 has, in a position corresponding to the inspection hole 443 of the spacer attaching plate 44, an inspection hole 453, whose dimension is approximately the same as the former inspection hole.

By using these jigs, the long spacer 111 and the short spacer 112 are crossed and implanted into the through-hole 441 of the spacer attaching plate 44; and, after performing a positional alignment by utilizing the inspection hole 443, both spacers are positioned by being vertically pressed via their plate faces by the leaf springs 46 disposed in the spring accommodation parts 442. Thereafter, the spacer fixing plate 45 is mounted on the spacer attaching plate 44; and, after performing a positional alignment by utilizing the inspection hole 453, a load is applied from the upper side of the spacer fixing plate 45, and the spacer assembly 11 is fusion-bonded and fixed to the front face substrate 2, while being heated at temperatures of about 450° C., if an electrically conductive member of silver paste is used, for instance.

Here, it is desirable that the jig, such as the spacer attaching plate and the spacer fixing plate for fixing the spacer, is constituted by a material whose coefficient of thermal expansion approximately coincides with or is nearly equal to that of the substrate etc., from the point of view of suppressing a displacement at the fusion-bonding and fixing time and from the point of view of easiness in detaching the jigs after the elements have been fixed. Further, the spacer can be manufactured from a ceramic block, in which the engaging part has been previously provided, by cutting it to have a desired shape and thickness, so that it can be inexpensively available.

According to this embodiment, from the fact that in the spacer assembly, the two spacers are secured by being combined at the engaging parts in a self-sustainable shape, the spacer assembly can be erected on the front face substrate, and, from the fact that it is possible to prevent the spacer from inclining, a high quality display device can be provided. Further, since the mutual position between the jig and the front face substrate can be kept constant at the securing time, a distortion is not likely to occur in the front face s substrate after the securing. Additionally, it is easy to detach the jig after the securing, so that the spacer is not likely to be damaged at the detaching time.

### Embodiment 8

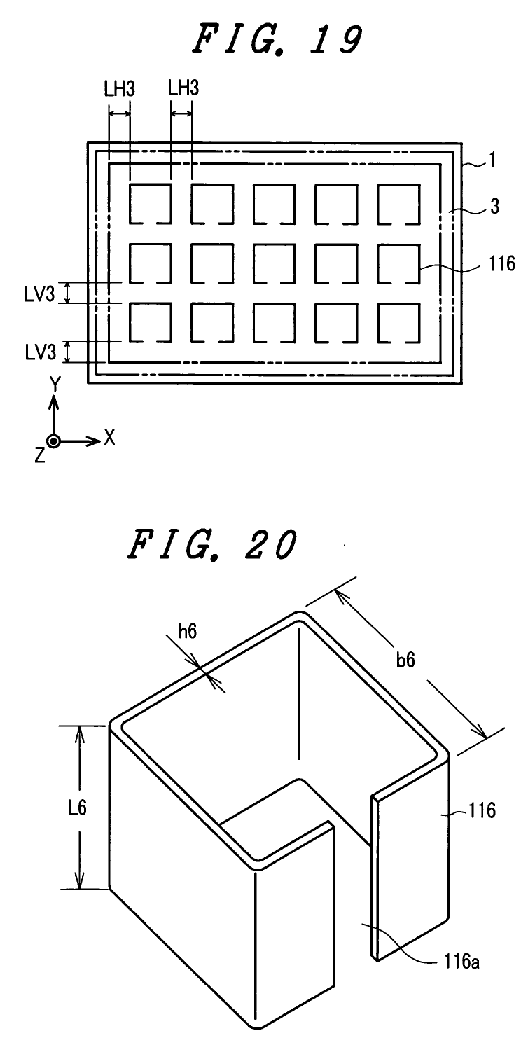

FIG. 19 is a plan view showing still another example of the disposition of a spacer in the present display device of the invention, and FIG. 20 a perspective view showing still another example of the spacer of the present invention. A spacer 116, as shown in detail in FIG. 20, has the shape of an approximately angular tube that is L6 in height, h6 in thickness and b6 in the length of its one side. In one face of the spacer 116, there has been provided an opening 116a facing in a direction approximately parallel to its axis, so that the spacer 116 has a self-sustainable constitution as a unit. The plural spacers 116 are disposed over the whole area of the display region 6 in the Y-direction at an equal interval with an interval, between the mutual spacers and an interval between the outermost spacer and the support body 3 in the Y-direction being respectively LV3. Additionally, the plural spacer assemblies are disposed in the X-direction at an equal interval, with an interval between the plural-row mutual spacers and an interval between the outermost spacer and the support body 3 in the X-direction being respectively LH3, whereby each spacer 116, is capable of uniformly retaining the substrate.

In this embodiment, by using one kind of spacer, the load is uniformly applied to each spacer, and thus it is possible to prevent damage to the spacer. Further, the jig structure used when fixing the spacer can be simplified, and, in addition, the work management becomes easy. Additionally, from the fact that each spacer has a self-sustainable constitution as a unit, the work required for fixing it to the substrate becomes easy, and it has the characteristic that the mutual position with respect to each electrode can be accurately controlled, and, needless to say, it is possible to improve the workability.

As mentioned above, by specifying the disposition of the spacer assembly on the basis of the buckling strength, the limit compressive stress, the load and the like, it is possible to provide a display device whose reliability is high and in which cracking of the substrate is eliminated, and buckling of the spacer assembly is eliminated as well. Further, from the fact that the spacer assembly has a self-sustainable constitution, the work required for fixing it to the substrate becomes easy, and it has the characteristic that the mutual position with respect to each electrode can be accurately controlled, and, needless to say, it is possible to improve the workability.

Additionally, since the mutual position with respect to the spacer assembly can be kept constant when secured to the substrate, it is possible to avoid distortion of the substrate after the assembly, so that it is possible to provide a display device whose dimensional accuracy is high. Further additionally, the plate-like spacers can be made into a spacer assembly of a self-sustainable aggregate via combining them by the engaging parts, so that a securing of the spacer assembly also can be easily performed.

1. A display device which possesses:
a front face substrate having in its inner face an anode and a fluorescent substance,
a back face substrate having in its inner face plural electron sources and facing on the front face substrate with a predetermined spacing from the front face substrate,
plural spacing retaining members disposed in a display region between the front face substrate and the back face substrate and retaining the predetermined spacing, and
a support body interposed between the front face substrate and the back face substrate while encircling the display region to thereby retain the predetermined spacing, and
in which end faces of the support body and the front face substrate and the back face substrate are respectively air-tightly seal-bonded through a seal-bonding member,
characterized in that a relation among a limit compressive stress σₖ of both the substrates, a number S and a buckling load Pₖ of the spacing retaining members exists in a range of
1≦σₖ·S/Pₖ<10.

2. A display device according to claim 1, characterized in that the relation among the limit compressive stress σₖ of both the substrates, the number S and the buckling load Pₖ of the spacing retaining members exists in a range of
3≦σₖ·S/Pₖ<5.

3. A display device according to claim 1, characterized in that the spacing retaining member comprises a ceramics material.

4. A display device according to claim 1, characterized in that the spacing retaining member is made into an aggregate of a self-sustainable constitution by combining plural support members, and the spacing retaining member is disposed in the display region by plural sets.

5. A display device according to claim 4, characterized in that the spacing retaining member comprises a combination of the support members whose heights are different.

6. A display device according to claim 4, characterized in that at least one part of the support member constituting the spacing retaining member possesses an engaging part for combining.

7. A display device according to claim 6, characterized in that the engaging part comprises an approximately rectangular concave part extending from an opening in one end face side toward other end face.

8. A display device according to claim 7, characterized in that a depth of the concave part is ⅔- 7/15 of a height of the support member, and the concave part does not contact with a concave part bottom face of other engaging support member.

9. A display device according to claim 1, characterized in that the spacing retaining member is fixed to the substrate by an electrically conductive member.

10. A display device according to claim 1, characterized in that the spacing retaining member has in its surface a resistive layer.

11. A display device according to claim 1, characterized in that the spacing retaining member has a self-sustainable constitution by a unit, and the spacing retaining member is dispersion-disposed in the display region by plural pieces.
